(19) United States
(12) Patent Application Publication
(10) Pub. No.: US 2010/0183885 A1
(43) Pub. Date: Jul. 22, 2010

(54) BONDING METHOD OF SILICON BASE MEMBERS, DROPLET EJECTION HEAD, DROPLET EJECTION APPARATUS, AND ELECTRONIC DEVICE

(75) Inventors: Mitsuru Sato, Nagano (JP); Yoshiaki Mori, Nagano (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/665,028

(22) PCT Filed: Jun. 16, 2008
(86) PCT No.: PCT/JP2008/060985

§ 371 Date: Dec. 16, 2009

(30) Foreign Application Priority Data
Jun. 18, 2007 (JP) 2007-160796
Jun. 2, 2008 (JP) 2008-145157

(51) Int. Cl. B32B 37/02; B32B 38/00; B05B 1/00; B32B 9/04

(52) U.S. Cl. 428/446; 156/60; 156/272.8; 216/99; 239/589

(57) ABSTRACT

A bonding method of silicon base members is provided. The bonding method of silicon base members comprises: applying an energy to a first silicon base member including Si—H bonds to selectively cut the Si—H bonds so that the first silicon base member is cleaved and divided to one silicon base member and the other silicon base member, and the one silicon base member having a cleavage surface and dangling bonds of silicon obtained by cutting the Si—H bonds; and bonding the cleavage surface of the one silicon base member and a surface of a second silicon base member on which dangling bonds of silicon are exposed to thereby bond the cleavage surface and the surface together through their dangling bonds.

### CROSS-REFERENCE TO RELATED APPLICATION

This application claims priorities to Japanese Patent Application No. 2007-160796 filed on Jun. 18, 2007 and Japanese Patent Application No. 2008-145157 filed on Jun. 2, 2008 which are hereby expressly incorporated by reference herein in their entireties.

### BACKGROUND

1. Technical Field

The present invention relates to a bonding method of silicon base members, a droplet ejection head, a droplet ejection apparatus, and an electronic device, and more specifically relates to a bonding method of silicon base members, a droplet ejection head provide with a bonded body manufactured by the bonding method, a droplet ejection apparatus provided with the droplet ejection head, and an electronic device provided with the bonded body.

2. Related Art

Conventionally, as a method of bonding two silicon substrates (silicon base members) to each other, there is known a wafer direct bonding method which is a method of directly bonding two wafers (silicon substrates) to each other.

Generally, the wafer direct bonding method is performed as follows. First, two silicon substrates are washed. Then, they are subjected to a surface treatment to thereby bond a large number of hydroxyl groups on the surfaces of the two silicon substrates. Thereafter, the surface-treated surfaces of the two silicon substrates are overlapped to each other. Next, the overlapped two silicon substrates are subjected to a heating treatment at a temperature of about 1000° C. to bond the two silicon substrates together.

In this way, when the wafer direct bonding method is performed by overlapping the surfaces of the two silicon substrates to which the hydroxyl groups have been bonded, and then subjecting the overlapped two silicon substrates to the heating treatment, Si—O—Si bonds are produced by reacting Si—OH bonds to each other which exist on the surface of each of the two silicon substrates. That is, the Si—O—Si bonds are produced by dehydration between the Si—OH bonds.

The Si—O—Si bonds make it possible to firmly bond the two silicon substrates. Since no adhesive is used in this wafer direct bonding method, there is no problem that the adhesive gets out of between the two silicon substrates. The wafer direct bonding method makes it possible to accurately bond the two silicon substrates together with an easy process. Therefore, the wafer direct bonding method is expected to be used in various applications such as MEMS (Micro Electro Mechanical Systems) assembling, a semiconductor elements, various kinds of packages, and the like.

However, a conventional wafer direct bonding method requires a heating treatment at a temperature of about 1000° C. Therefore, in a case where an electronic circuit and a movable structural body are formed in a silicon substrate, there is a problem in that the electronic circuit and the movable structural body are damaged due to the heat.

In such a case, at least one of the surfaces of the two silicon substrates is subjected to a hydrophilic treatment with oxygen plasma obtained by using a plasma generation apparatus. Thereafter, the hydrophilic-treated surfaces are overlapped to each other, and then the overlapped silicon substrates are subjected to a heating treatment at a temperature in the range of 200 to 450° C. One example of such a bonding method is disclosed in a patent document.

However, the above bonding method is performed by bonding the two silicon substrates to each other through the Si—O—Si bonds. Therefore, sufficient bonding strength cannot be obtained. Additionally, chemical bonds exist nonuniformly in (on) a bonding surface between the two silicon substrates, thereby lowering mechanical characteristics, electrical characteristics, and chemical characteristics in (on) the bonding surface.

Therefore, in a case where a semiconductor device is manufactured by bonding a p-type silicon substrate and an n-type silicon substrate together, contact resistance due to the Si—O—Si bonds is caused in the bonding surface between the two silicon substrates. As a result, there is a fear that characteristics of the semiconductor device are lowered.

Generally, a surface of a silicon substrate is smoothed by a mechanical polishing or a chemical polishing. However, such a polished surface cannot have sufficient smoothness property. Therefore, it is difficult to bond the silicon substrates, which have been subjected to a polishing treatment, together with high strength and high accuracy without gaps therebetween.

The patent document is JP A-5-82404 as an example of related art.

### SUMMARY

Accordingly, it is an object of the present invention to provide a bonding method of silicon base members being capable of firmly and accurately bonding the silicon base members together without subjecting them to a heating treatment at a high temperature.

Further, it is another object of the present invention to provide a droplet ejection head having reliability and including a bonded body manufactured by using such a bonding method, and a droplet ejection apparatus provided with such a droplet ejection head.

Furthermore, it is other object of the present invention to provide an electronic device including the bonded body manufactured by using such a bonding method.

These objects are achieved by the present invention described below.

In a first aspect of the present invention, there is provided a bonding method. The bonding method comprises: applying an energy to a first silicon base member including Si—H bonds to selectively cut the Si—H bonds so that the first silicon base member is cleaved and divided to one silicon base member and the other silicon base member, and the one silicon base member having a cleavage surface and dangling bonds of silicon obtained by cutting the Si—H bonds; and bonding the cleavage surface of the one silicon base member and a surface of a second silicon base member on which dangling bonds of silicon are exposed to thereby bond the cleavage surface and the surface together through their dangling bonds.

According to such a bonding method of the present invention, it is possible to firmly and accurately bonding silicon base members together without subjecting them to a heating treatment at a high temperature.

In the above bonding method, it is preferred that the first silicon base member is constituted of hydrogenated amorphous silicon or crystal silicon including hydrogen.

According to such a bonding method of the present invention, it is possible to reliably cleave the first silicon base member.

In the above bonding method, it is also preferred that the first silicon base member constituted of the hydrogenated amorphous silicon is formed by a CVD method or a plasma polymerization method using a silane gas as a raw gas.

According to such a bonding method of the present invention, it is possible to efficiently produce a first silicon base member constituted of hydrogenated amorphous silicon.

In the above bonding method, it is also preferred that the energy includes a laser light, and the applying the energy to the first silicon base member is performed by irradiating the laser light to the first silicon base member.

According to such a bonding method of the present invention, it is possible to selectively and efficiently cut the Si—H bonds while preventing the first silicon base member from being altered and deteriorated. Moreover, it is possible to locally apply energy to a surface of the first silicon base member to be cleaved. Therefore, it is possible to selectively cut only the Si—H bonds existing in the vicinity of the surface of the first silicon base member to be cleaved.

In the above bonding method, it is also preferred that the laser light includes a pulse laser.

According to such a bonding method of the present invention, heat is difficult to be accumulated in a surface of the first silicon base member, in which the laser light has been irradiated, over time. Therefore, it is possible to reliably prevent the first silicon base member from being altered and deteriorated due to the accumulated heat. As a result, it is possible to accurately determine positions of the Si—H bonds to be cut, so that it is possible to accurately determine positions to be cleaved.

In the above bonding method, it is also preferred that the first silicon base member has a part in which the laser light has been irradiated, and conditions of irradiating the laser light to the first silicon base member are adjusted so that a temperature of the part is in the range of 300 to 600° C.

According to such a bonding method of the present invention, it is possible to selectively cut only the Si—H bonds at the part of the first silicon base member in which the laser light has been irradiated without cutting most of the Si—Si bonds.

In the above bonding method, it is also preferred that the first silicon base member has a surface to be cleaved, and the applying the energy to the first silicon base member is performed by scanning the laser light along the surface to be cleaved in a state that the laser light is focused to the surface of the first silicon base member to be cleaved.

According to such a bonding method of the present invention, the heat generated by irradiating the laser light is locally accumulated at the vicinity of the surface of the first silicon base member to be cleaved. As a result, the Si—H bonds existing along the surface of the first silicon base member to be cleaved are selectively cut.

In the above bonding method, it is also preferred that the Si—H bonds included in the first silicon base member are distributed along the surface of the first silicon base member to be cleaved.

According to such a bonding method of the present invention, even if a light having low directionality which spreads in a radial fashion is used instead of a light having high directionality such as a laser light, it is possible to selectively cut only the Si—H bonds existing on the surface of the first silicon base member to be cleaved. Therefore, it is possible to reliably cleave the first silicon base member at the surface thereof to be cleaved to thereby divide the first silicon base member.

In the above bonding method, it is also preferred that the first silicon base member in which the Si—H bonds are distributed along the surface to be cleaved is constituted of a silicon material formed by implanting hydrogen atoms or hydrogen ions into the surface to be cleaved.

According to such a bonding method of the present invention, even if the first silicon base member is constituted of a silicon material containing no hydrogen preliminarily, it is possible to reliably bond the first and second silicon base members together.

In the above bonding method, it is also preferred that the silicon material is crystal silicon having a crystal surface, the crystal surface of the crystal silicon is substantially parallel to the surface of the first silicon base member to be cleaved.

According to such a bonding method of the present invention, since the cleavage is produced along a crystal surface of the first silicon base member, it becomes possible for the obtained cleavage surface to exhibit high smoothness property.

In the above bonding method, it is also preferred that the first silicon base member is cleaved at the surface to be cleaved by heating the first silicon base member.

According to such a bonding method of the present invention, it is possible to perform the heating process with ease without use of expensive equipment.

In the above bonding method, it is also preferred that a temperature of heating the first silicon base member is in the range of 300 to 600° C.

According to such a bonding method of the present invention, it is possible to selectively cut only the Si—H bonds without cutting most of the Si—Si bonds.

In the above bonding method, it is also preferred that the bonding the cleavage surface of the one silicon base member and the surface of the second silicon base member is performed with heating the one silicon base member and the second silicon base member.

According to such a bonding method of the present invention, it is possible to increase the bonding strength of a bonded body with reduced of bonding time.

In the above bonding method, it is also preferred that a temperature of heating the one silicon base member and the second silicon base member is in the range of 40 to 200° C.

According to such a bonding method of the present invention, it is possible to prevent the cleaved first silicon base member and the second silicon base member from being altered and deteriorated due to the heat. In addition, it is possible to increase the bonding strength of the bonded body with reduced of bonding time.

In the above bonding method, it is also preferred that the bonding the cleavage surface of the one silicon base member and the surface of the second silicon base member is performed with pressing the one silicon base member and the second silicon base member in a direction of approaching them to each other.

According to such a bonding method of the present invention, it is possible to increase the bonding strength of the bonded body.

In the above bonding method, it is also preferred that a pressure of pressing the one silicon base member and the second silicon base member is in the range of 1 to 1000 MPa.

According to such a bonding method of the present invention, it is possible to reliably increase the bonding strength of the bonded body while preventing the first and second silicon base members from being damaged.

In the above bonding method, it is also preferred that the applying the energy to the first silicon base member and the bonding the cleavage surface of the one silicon base member and the surface of the second silicon base member are performed in an inert gas atmosphere or a reduced-pressure atmosphere.

According to such a bonding method of the present invention, it is possible to reliably prevent the cleavage surface of the cleaved first silicon base member and the surface of the second silicon base member from being polluted and oxidized by adhesion of oxygen and moisture contained in an atmosphere. As a result, it is possible to prevent the dangling bonds exposed on the cleavage surface and the surface of the second silicon base member from being undesirably end-capped by oxygen and moisture.

In the above bonding method, it is also preferred that the second silicon base member is provided by providing a silicon base member including Si—H bonds; and applying an energy to the silicon base member to selectively cut the Si—H bonds included in the silicon base member to obtain the exposed dangling bonds of silicon so that the silicon base member is cleaved and divided to the second silicon base member and a silicon base member.

According to such a bonding method of the present invention, a cleavage surface formed by cleaving the second silicon base member has higher smoothness property than that of a polished surface of a silicon base member. Therefore, it is possible to improve adhesion of a bonding interface between one first silicon base member obtained by cleaving and dividing the first silicon base member and one second silicon base member obtained by cleaving and dividing the second silicon base member by using the bonding method according to the present invention. This makes it possible to obtain a bonded body having high bonding strength.

In the above bonding method, it is also preferred that the second silicon base member is provided by: providing a silicon base member having a surface; subjecting the silicon base member to an etching treatment using a hydrofluoric acid-containing liquid to form Si—H bonds on the surface of the silicon base member; and applying an energy to the etching-treated surface of the silicon base member to selectively cut the Si—H bonds so that the dangling bonds are exposed on the surface of the silicon base member corresponding to the second silicon base member.

According to such a bonding method of the present invention, it is possible to apply the bonding method to the second silicon base member containing no hydrogen.

In a second aspect of the present invention, there is provided a droplet ejection head. The droplet ejection head is provided with a bonded body manufactured by bonding two silicon base members together, wherein the bonded body is manufactured by the bonding method of the silicon base members described above.

Such a droplet ejection head can have high reliability.

In a third aspect of the present invention, there is provided a droplet ejection apparatus provided with the droplet ejection head described above.

Such a droplet ejection apparatus can have high reliability.

In a fourth aspect of the present invention, there is provided an electronic device provided with a bonded body manufactured by bonding two silicon base members together, wherein the bonded body is manufactured by the bonding method of the silicon base members described above.

Such a electronic device can have high reliability.

### BRIEF DESCRIPTION OF THE DRAWINGS

FIGS. 1A to 1D are vertical sectional views for explaining a first embodiment of a bonding method of silicon base members according to the present invention.

FIGS. 2E to 2G are vertical sectional views for explaining a first embodiment of a bonding method of silicon base members according to the present invention.

FIGS. 3H and 3I are vertical sectional views for explaining a first embodiment of a bonding method of silicon base members according to the present invention.

FIGS. 4A to 4C2 are vertical sectional views for explaining a second embodiment of a bonding method of silicon base members according to the present invention.

FIGS. 5D and 5E are vertical sectional views for explaining a second embodiment of a bonding method of silicon base members according to the present invention.

FIG. 6 is a vertical sectional view showing a diode produced by using the bonding method of the silicon base members according to the present invention.

FIG. 7 is an exploded perspective view showing a droplet ejection head produced by using the bonding method of the silicon base members according to the present invention, wherein the droplet ejection head is configured as an ink jet type recording head.

FIG. 8 is a sectional view of the ink jet type recording head shown in FIG. 7.

FIG. 9 is a schematic view showing one embodiment of an ink jet printer provided with the ink jet type recording head shown in FIG. 7.

FIG. 10 is a vertical sectional view showing an electronic device produced by using the bonding method of the silicon base members according to the present invention.

### DESCRIPTION OF EXEMPLARY EMBODIMENTS

Hereinbelow, a bonding method of silicon base members, a droplet ejection head, a droplet ejection apparatus, and an electronic device according to the present invention will be described in detail with reference to preferred embodiments shown in the accompanying drawings.

Bonding Method of Silicon Base Members

### First Embodiment

First, a description will be made on a first embodiment of a bonding method of silicon base members according to the present invention.

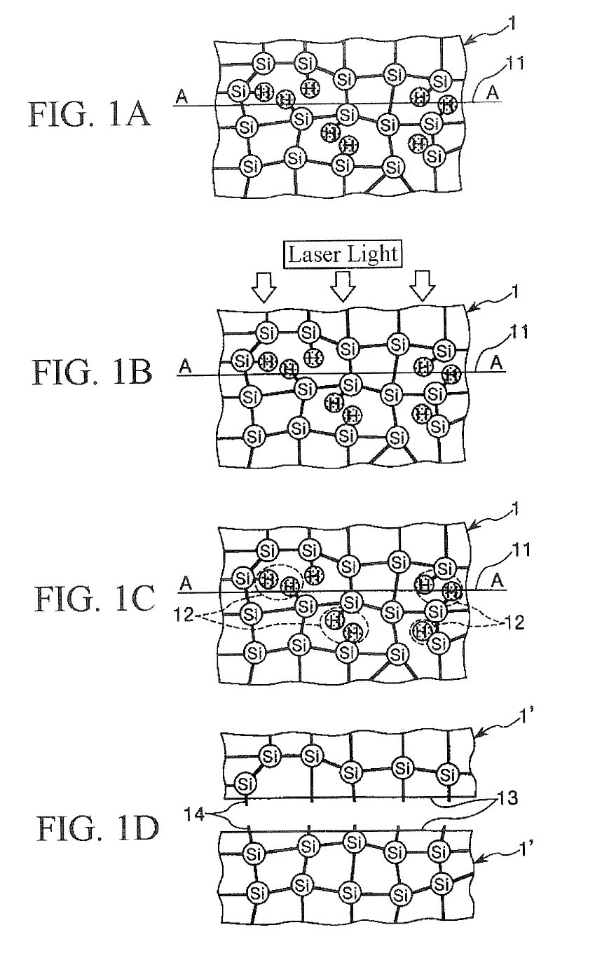

FIGS. 1A to 3I are vertical sectional views for explaining a first embodiment of a bonding method of silicon base members according to the present invention. In the following description, the upper side in each of FIGS. 1A to 1D, 2E to 2G, and 3H and 3I will be referred to as “upper” and the lower side thereof will be referred to as “lower” for convenience of explanation.

The bonding method of the silicon base members according to the present invention is a method of bonding surfaces of two silicon base members (a first silicon base member 1 and a second silicon base member 2) together by directly being into contact with them. Such a bonding method of the silicon base members includes the following two steps.

[1] A first step is a cleavage step of cleaving the first silicon base member 1. [2] A second step is a bonding step of providing the second silicon base member 2, and then bonding a cleavage surface 13 of the cleaved first silicon base member 1 and a surface 21 of the second silicon base member 2 to thereby bond them together. Hereinafter, a description will be made on each step one after another.

[1] Cleavage Step of First Silicon Base Member (First Step)

In this embodiment, the first step includes [1-1] a step of providing the first silicon base member 1 including Si—H bonds and [1-2] a step of applying energy to the first silicon base member 1. By performing these steps, the Si—H bonds are cut selectively to remove hydrogen atoms from the Si—H bonds, and then the removed hydrogen atoms are bonded to each other to thereby generate a hydrogen gas.

A large volume of this hydrogen gas is occupied in the first silicon base member 1. Therefore, the first silicon base member 1 is pushed up at parts therein where the hydrogen gas has been generated, thereby cleaving the first silicon base member 1. Hereinafter, a description will be made on the steps one after another.

In this regard, it is to be noted that the first silicon base member is cleaved along an A-A line shown in FIGS. 1A to 1C in this embodiment. Hereinafter, a surface shown by the A-A line is referred to as “surface 11 to be cleaved” or simply “surface 11”. Hereinafter, the description will be made on the steps one after another.

[1-1] The first silicon base member 1 including the Si—H bonds, which is provided in this step, is constituted of a silicon material having a chemical structure containing the Si—H bonds in addition to Si—Si bonds as a chemical bond.

Specifically, examples of the silicon material constituting the first silicon base member 1 include: (A) amorphous silicon, in which hydrogen is added, such hydrogenated amorphous silicon; (B) crystalline silicon such as monocrystalline silicon in which hydrogen is added, and polycrystalline silicon; and the like. Such amorphous silicon and crystalline silicon make it possible to reliably cleave the first silicon base member 1. Hereinafter, the description will be made on the silicon material about the items (A) and (B) one after another.

(A) Hydrogenated amorphous silicon can be produced by using a vapor deposition method, a sputter method, various kinds of CVD methods such as a plasma CVD method and a heat CVD method, a plasma polymerization method, and the like.

It is preferred that hydrogenated amorphous silicon produced by the CVD method using a silane-based gas such as silane (SiH₄) and disilane (Si₂H₆) as a raw gas is used as the silicon material constituting the first silicon base member 1. Hydrogenated amorphous silicon produced by such a method is a material in which silicon atoms are not regularly arranged as a crystal structure but randomly arranged.

In this hydrogenated amorphous silicon, molecules of hydrogen contained in the raw gas are entirely taken in a film constituted of hydrogenated amorphous silicon. Then, the non-bonding hands (dangling bonds) of silicon are end-capped with hydrogen, thereby forming the Si—H bonds. In this way, the CVD method using silane makes it possible to efficiently produce hydrogenated amorphous silicon (first silicon base member 1).

Likewise, it is preferred that hydrogenated amorphous silicon produced by the plasma polymerization method using an organosiloxane-based gas as the raw gas is also used as the silicon material constituting the first silicon base member 1.

Hydrogenated amorphous silicon produced by such a method is a material in which the silicon atoms, oxygen atoms, and organic groups are not regularly arranged as the crystal structure but randomly arranged.

In this hydrogenated amorphous silicon, the molecules of hydrogen contained in the raw gas are entirely taken in a film constituted of hydrogenated amorphous silicon. Then, the non-bonding hands (dangling bonds) of silicon are end-capped with hydrogen, thereby forming the Si—H bonds. In this way, the plasma polymerization method using the organosiloxane-based gas also makes it possible to efficiently produce hydrogenated amorphous silicon (first silicon base member 1).

Examples of such a raw gas include: organosiloxane such as methyl siloxane, octamethyl trisiloxane, decamethyl tetrasilixane, decamethyl cyclopentasiloxane, octamethyl cyclotetrasiloxane, and methylphenylsiloxane; and the like.

If the CVD method and the plasma polymerization method are performed by using a mask and the like, it is possible to selectively form the film constituted of hydrogenated amorphous silicon on only a predetermined region of a substrate. This makes it possible obtain an advantage that the first silicon base material 1 can be formed in a predetermined shape.

After the film constituted of hydrogenated amorphous silicon is formed on an entire substrate having a large area, the film may be subjected to a patterning process in combination of a photolithographic technique and an etching technique. The use of such a process also makes it possible to form the first silicon base material 1 having a predetermined shape with ease.

A content of hydrogen contained in hydrogenated amorphous silicon is preferably in the range of about 0.5 to 20 atom %, and more preferably in the range of about 1 to 15 atom %. If the content of hydrogen contained in hydrogenated amorphous silicon falls within the above-noted range, it is possible to reliably cleave the first silicon base member 1.

If the content of hydrogen contained in hydrogenated amorphous silicon is smaller than the lower limit value noted above, the hydrogen gas hardly is generated by cutting the Si—H bonds. Therefore, the first silicon base member 1 cannot be sufficiently pushed up by the hydrogen gas, so that there is a fear that it becomes difficult that the first silicon base member 1 is cleaved.

On the other hand, if the content of hydrogen contained in hydrogenated amorphous silicon exceeds the upper limit value noted above, various kinds of characteristics of hydrogenated amorphous silicon is lowered. For example, if the content of hydrogen contained in hydrogenated amorphous silicon exceeds the upper limit value noted above, hydrogenated amorphous silicon is embrittled, so that there is a fear that mechanical characteristics thereof are lowered.

Additionally, the content of hydrogen contained in hydrogenated amorphous silicon is too large. Therefore, it is difficult for such hydrogenated amorphous silicon to set conditions of producing a film by using a present film formation technology, so that there is a possibility that mass productivity of the film is lowered.

In the meantime, in a case where hydrogenated amorphous silicon is formed by the plasma CVD method, the content of hydrogen contained in hydrogenated amorphous silicon can be controlled by appropriately setting various kinds of parameters. Examples of the various kinds of the parameters include a composition of the raw gas, a flow rate thereof, an output of plasma, a pressure inside a chamber in a plasma CVD apparatus, a temperature of the film formation, and the like.

Likewise, in a case where hydrogenated amorphous silicon is formed by the plasma polymerization method, the content of hydrogen contained in hydrogenated amorphous silicon can be controlled by appropriately setting various kinds of parameters. Examples of the various kinds of the parameters include a composition of the raw gas, an output of plasma (output density of a high-frequency voltage), and the like.

Specifically, by improving the output density of the high-frequency voltage, it is possible to improve the content of hydrogen contained in hydrogenated amorphous silicon.

The output density of the high-frequency voltage is not particularly limited to a specific value, but is preferably in the range of about 0.01 to 100 W/cm², more preferably in the range of about 0.1 to 50 W/cm² and even more preferably in the range of about 1 to 40 W/cm².

A frequency of the high-frequency voltage is not particularly limited to a specific value, but is preferably in the range of about 1 kHz to 100 MHz and more preferably in the range of about 10 to 60 MHz.

(B) The crystalline silicon is a crystalline material having a diamond-type crystal structure.

In the monocrystalline silicon of the crystalline silicon, silicon atoms are regularly arranged in the entire material. In contrast, the polycrystalline silicon is a material which is formed by gathering particles of monocrystalline silicon having a different plane direction.

Such crystalline silicon, normally, is not contained hydrogen just after production thereof. Therefore, after crystalline silicon is produced, one in which hydrogen atoms or hydrogen ions are added can be used as the first silicon base member 1. In crystalline silicon in which the hydrogen atoms or the hydrogen ions are added, the Si—H bonds are formed by bonding the added hydrogen atoms or hydrogen ions and silicons constituting a crystal structure together.

A method of adding the hydrogen atoms or the hydrogen ions to crystalline silicon is not limited to a specific method, but includes an ion implantation method using ion implantation equipment and the like.

In the ion implantation method, hydrogen (hydrogen atoms or hydrogen ions) is added to crystalline silicon by implanting the hydrogen ions accelerated by electrical fields from the surface of a film constituted of crystalline silicon. At this time, the implantation of the hydrogen ions is preferably performed from the opposite surface of the surface to be bonded to the second silicon base member 2 in the step [2] described later.

This makes it possible to prevent the first silicon base member 1′ to be bonded to the second silicon base member 2 from being damaged by the ion implantation after cleavage step [2] described later. Consequently, finally the produced bonded body 3 can obtain superior characteristics.

In this regard, it is to be noted that hydrogen (hydrogen ions or hydrogen atoms) may exist to at least the surface 11 to be cleaved in crystal silicon to which hydrogen is added in this embodiment. In other words, hydrogen may be added to the whole of the first silicon base member 1 and locally added to the vicinity of the surface 11 to be cleaved.

Further, it is preferred that a crystal surface of the first silicon base member 1 constituted of crystalline silicon is parallel to the surface 11 to be cleaved. Since this helps that the cleavage is generated along the crystal surface, the obtained cleavage surface 13 has high smoothness property.

A p-type dopant and an n-type dopant, if necessary, may be added to the first silicon base member 1. This makes it possible to control electrical characteristics of the first silicon base member 1. As described above, the first silicon base member 1 can be produced by the methods of the items (A) and (B).

[1-2] Next, energy is applied to the first silicon base member 1.

A method of applying the energy to the first silicon base member 1 is not limited a specific method as long as the Si—H bonds are selectively cut without altering and deteriorating the first silicon base member 1, but various kinds of methods can be used.

Here, a bonding energy of the Si—H bonds is in the range of about 3.1 to 3.5 eV. A bonding energy of the Si—Si bonds is about 7.6 eV. There is some degree of difference between the bonding energies of the Si—H bonds and the Si—Si bonds. Therefore, only the Si—H bonds can be selectively cut by controlling an amount of the energy to be applied to the first silicon base member 1 in a state that the Si—Si bonds are hardly cut.

Likewise, the bonding energy of the Si—H bonds is lower than those of the Si—O bonds and the Si—C bonds. Therefore, only the Si—H bonds can be selectively cut by controlling the amount of the energy to be applied to the first silicon base member 1.

In this embodiment, a method of irradiating a laser light to the first silicon base member 1 is used as the method of applying the energy thereto as shown in FIG. 1B. According to the laser light, it is possible to selectively and efficiently cut the Si—H bonds while preventing the first silicon base member 1 from being altered and deteriorated.

Further, according to the laser light, it is possible to locally apply the energy to the surface 11 to be cleaved of the first silicon base member 1. Such a method makes it possible to selectively cut only the Si—H bonds existing at the vicinity of the surface 11 to be cleaved.

Examples of the laser light include: a pulse oscillation laser (a pulse laser) such as an excimer laser; a continuous oscillation laser such as a carbon dioxide laser or a semiconductor laser; and the like. Among these lasers, it is preferred that the pulse laser is used in this embodiment.

Use of the pulse laser makes it difficult to accumulate heat in a portion of the first silicon base member 1 where the laser light is irradiated with time. Therefore, it is possible to reliably prevent alteration and deterioration of the first silicon base member 1 due to the heat accumulated.

Since it is difficult to accumulate the heat in a portion of the first silicon base member 1 where the laser light is irradiated, temperature increase can be suppressed as much as possible even if the heat has been spread around the portion. Therefore, it is possible to prevent the energy from being applied from the irradiated portion to a distance portion.

That is, it is possible to selectively apply the energy to the portion to be irradiated. This makes it possible to cut the intended Si—H bonds with high accuracy, thereby enabling a cleavage position of the first silicon base member 1 to determine accurately.

In the continuous oscillation laser, before the heat accumulated in the portion of the first silicon base member 1 where the laser light has been irradiated over time is released and a temperature of the portion is lowered, the laser light is continuously irradiated to the portion the first silicon base member 1. For these reasons, there is a fear that a temperature of the irradiated portion becomes high temperature. This causes alteration and deterioration of the first silicon base member 1, and therefore there is a fear that accuracy of the cleavage position is lowered.

In the case where influence of the heat is taken into account, it is preferred that a pulse width of the pulse laser is as small as possible. Specifically, the pulse width is preferably equal to or smaller than 1 ps (picosecond), and more preferably equal to or smaller than 500 fs (femtoseconds). By setting the pulse width to the above range, it is possible to reliably suppress the influence of the heat generated in the first silicon base member 1 due to the irradiation with the laser light.

Further, by setting the pulse width to the above range, it is possible to prevent accumulate of the heat in the portion of the first silicon base member 1 where the laser light is irradiated, and expanse of the portion having a high temperature in a thickness direction of the first silicon base member 1 (that is, the irradiating direction of the laser light).

For these reasons, it is possible to adjust a cleavage position with high accuracy. In this regard, it is to be noted that the pulse laser having the small pulse width of the above range is called as “femtosecond laser”.

A wavelength of the laser light is not particularly limited to a specific value, but is preferably in the range of about 200 to 1200 nm, and more preferably in the range of about 300 to 1000 nm. Further, in the case of the pulse laser, peak power of the laser light is preferably in the range of about 0.1 to 10 W, and more preferably in the range of about 1 to 5 W, although being different depending on the pulse width thereof.

Moreover, a repetitive frequency of the pulse laser is preferably in the range of about 0.1 to 100 kHz, and more preferably in the range of about 1 to 10 kHz. By setting the frequency of the pulse laser to the above range, a temperature of a portion where the laser light is irradiated extremely rises and the Si—H bonds can be reliably cut while preventing the Si—Si bonds from being cut.

By appropriately setting various conditions for such a laser light, the temperature in the portion where the laser light is irradiated is adjusted so as to be preferably in the range of about 300 to 600° C., and more preferably in the range of 400 to 500° C., appropriately. This temperature makes it possible to selectively cut only the Si—H bonds at the portion where the laser light is irradiated without cutting most of Si—Si bonds.

Particularly, in a case where the first silicon base member 1 is constituted of amorphous silicon, a temperature of the irradiated portion becomes too high, and therefore it is possible to reliably prevent amorphous silicon from being crystallized.

The laser light irradiated on the first silicon base member 1 is preferably scanned along the surface 11 of the first silicon base member 1 to be cleaved with a focus thereof set on the surface 11 to be cleaved. By doing so, heat generated by the irradiation of the laser light is locally accumulated at the vicinity of the surface 11 to be cleaved. As a result, it is possible to selectively cut the Si—H bonds existing along the surface 11 to be cleaved.

When the Si—H bonds are cut, bonding hands of silicon atoms to which hydrogen atoms has been bonded become non-bonding hands (dangling bonds) 14. On the other hand, two hydrogen atoms eliminated (removed) from the silicon bonds are bonded to each other, so that a hydrogen gas 12 is generated at the vicinity of the surface 11 of the first silicon base member 1 to be cleaved as shown in FIG. 1C.

A large volume of this hydrogen gas is occupied in the first silicon base member 1. Therefore, the first silicon base member 1 is pushed up at the surface 11 to be cleaved. If stress generated by this reaches fracture stress of the first silicon base member 1, the cleavage is generated at the surface 11 of the first silicon base member 1 to be cleaved in an up-down direction, thereby dividing the first silicon base member 1 as shown in FIG. 1D. In this way, two first silicon base members 1′ are obtained, which are referred to as one first silicon base member 1′ and the other first silicon base member 1′.

The dangling bonds 14 of silicon atoms are exposed on cleavage surfaces 13 of the two first silicon base members 1′. This is a state of high activity. In this regard, it is to be noted that the cleavage surfaces 13 have higher smoothness property than that of a surface polished a silicon substrate.

It is preferred that the application of such energy is performed in a reduced-pressure atmosphere or an inert gas atmosphere such as a nitrogen gas atmosphere, an argon gas atmosphere and the like. This makes it possible to reliably prevent the cleavage surfaces 13 from being polluted or oxidized by adherence of oxygen and moisture contained in an atmosphere. As a result, it is possible to prevent dangling bonds 14 exposed on the cleavage surfaces 13 from being undesirably end-capped (non-activated) with oxygen and hydroxyl groups.

Further, in a case where hydrogen is added over the whole of the first silicon base member 1, it is recommended that a focus of the laser light is set on the surface 11 to be cleaved as described above. By doing so, even if hydrogen is distributed over the whole of the first silicon base member 1, it is possible to reliably cleave the first silicon base member 1 at the surface 11 to be cleaved thereof.

[2] Bonding Step of Silicon Base Members (Second Step)

The second step includes two steps of the following the steps [2-1] and [2-2]. The step [2-1] is a step of providing the second silicon base member 2 that the dangling bonds 22 of silicon are exposed on the surface 21 thereof. The step [2-2] is a step of overlapping the one first silicon base member 1′ and the second silicon base member 2 so as to be in contact the cleavage surface 13 of one first silicon base member 1′ which have been cleaved and divided in the step [1] with the surface 21 of the provided second silicon base member 2.

By performing the two steps, the dangling bonds 14 of silicon exposed on the cleavage surface 13 of the one first silicon base member 1′ are bonded to the dangling bonds 22 of silicon exposed on the surface 21 of the second silicon base member 2 to form Si—Si bonds. As a result, the one first silicon base member 1′ is bonded to the second silicon base member 2 to obtain a bonded body 3. Hereinafter, a description will be made on the steps one after another.

[2-1] The dangling bonds 22 of silicon are exposed on the surface 21 of the second silicon base member 2 provided in this step. A method of forming such a second silicon base member 2 is not limited to a specific method, but includes the following two steps (I) and (II).

(I) In this step, a silicon base member containing Si—H bonds is provided. In other words, the silicon base member is constituted of a silicon material having a chemical structure including the Si—H bonds. Then, the silicon base member is cleaved in the same manner as the step [1] described above. The thus-obtained cleaved silicon base member is used as a second silicon base member 2.

Specifically, firstly, a silicon base member including the Si—H bonds is provided. Then, energy is applied to the silicon base member. By doing so, the Si—H bonds are selectively cut, and then the hydrogen atoms eliminated (removed) from the silicon atoms are bonded to each other so that a hydrogen gas is generated. As a result, the silicon base member is pushed up at portions where the hydrogen gas is generated by the hydrogen gas to cleave the silicon base member. The dangling bonds of silicon are exposed on the surface of the cleaved and divided silicon base member.

In this regard, it is to be noted that the thus cleaved surfaces (cleavage surfaces) have higher smoothness property than that of a surface of a polished silicon base member. Therefore, if the one or the other first silicon base member 1′ obtained by the cleavage and the second silicon base member 2 obtained by the cleavage are used for the bonding method according to the present invention, it is possible to improve adhesion of the bonding interface between the one or the other first silicon base member 1′ and the second silicon base member 2. As a result, a bonded body 3 having high bonding strength is obtained.

(II) In this step, a silicon base member 5 including the Si—H bonds is provided. In other words, the silicon base member 5 is constituted of a silicon material having a chemical structure including Si—H bonds. A constituent material of the silicon base member 5 is the same as that of the first silicon base member 1.

Then, the provided silicon base member 5 is subjected to an etching treatment using a hydrofluoric acid-containing liquid. The hydrofluoric acid-containing liquid is a hydrofluoric acid-based etching liquid. Examples of such a hydrofluoric acid-based etching liquid include a hydrofluoric acid (HF) solution, a buffered hydrofluoric acid (mixture of hydrofluoric acid and ammonium fluoride (NH₄F)), and the like. Such a hydrofluoric acid-containing liquid has very high etching selectivity of oxide silicon with respect to silicon.

Therefore, if the hydrofluoric acid-containing liquid is used as an etching liquid, it is possible to selectively remove oxide silicon formed on the silicon base member 5 while preventing a base material (constituent material) of the silicon base member 5 from being deteriorated.

Generally, an oxide film constituted of oxide silicon is formed of the surface 51 of the silicon base member 5 due to oxygen and moisture contained in an atmosphere. However, only the oxide film can be selectively removed from the silicon base member 5 by the etching treatment using the hydrofluoric acid-containing liquid.

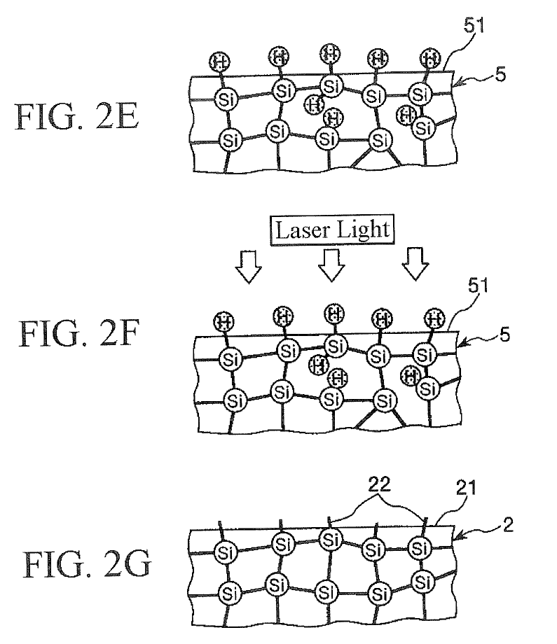

When the oxide film is removed from the surface 51 of the silicon base member 5, dangling bonds are exposed to the surface 51 of the silicon base member 5. However, hydrogen ions contained in the hydrofluoric acid-containing liquid are quickly bonded to the dangling bonds and the dangling bonds are end-capped by them as shown in FIG. 2E.

Next, energy is applied to the silicon base member 5, thereby selectively cutting the Si—H bonds included in the silicon base member 5. In this way, dangling bonds of silicon are exposed to the surface 51 of the silicon base member 5 as shown in FIG. 2G.

Examples of such a method of applying the energy to the silicon base member 5 include a method of irradiating an energy beam, a method of heating the silicon base member 5, and the like.

Examples of the energy beam include: a light such as an ultraviolet light and a laser light; an electron beam; a particle beam; and the like. Among these energy beams mentioned above, it is particularly preferred that the energy beams to be used are the ultraviolet light or the laser light (see FIG. 2F).

The use of such a laser light makes it possible to selectively and efficiency cut the Si—H bonds while preventing the silicon base member 5 from being altered and deteriorated as shown in FIG. 2G. Further, the use of such an ultraviolet light also makes it possible to selectively and efficiency cut the Si—H bonds over a large area (region) of the silicon base member 5 with relatively ease equipment such as an ultraviolet lump.

Here, a pulse laser is preferably used as the laser light like the step [1-2]. Various kinds of conditions of the laser light are the same as those of the step [1-2].

On the other hand, in a case where the ultraviolet light is used as the irradiated energy beam, a wavelength of the ultraviolet light is preferably in the range of about 150 to 300 nm, and even more preferably in the range of about 160 to 200 nm. Further, a time for irradiating the ultraviolet light is not limited to a specific value, but is preferably in the range of about 0.5 to 30 minutes and more preferably in the range of about 1 to 10 minutes.

If the dangling bonds 22 exposed onto the surface 51 are end-capped, the surface 51 of the silicon base member 5 becomes chemically stable. Therefore, even if the silicon base member 5 on which the dangling bonds 22 have been end-capped is left in an atmosphere, it is possible to prevent an oxide film from being formed on the surface 51 of the silicon base member 5.

In other words, it is possible to maintain a state that the Si—H bonds are formed on the surface 51 of the silicon base member 5 in high density. Therefore, such a state makes it possible to preserve or store the silicon base member 5 on which the dangling bonds 22 have been end-capped in even the atmosphere.

On the other hand, in a case where the silicon base member 5 is heated, a heating temperature of the silicon base member 5 is in the range of about 200 to 600° C., and even more preferably in the range of about 300 to 400° C. Since bonding energy of the Si—H bonds is smaller than that of the Si—Si bonds, it is possible to selectively cut the Si—H bonds by setting the heating temperature of the silicon base member 5 to fall within the above range.

According to the step (II), there is no necessity that a silicon base member always includes hydrogen. The bonding method according to the present invention can be used to a second base member 2 including no hydrogen.

According to the above two steps (I) and (II), it is possible to reliably and efficiently form the second silicon base member 2 that the dangling bonds 22 are exposed on the surface 21 thereof.

In this regard, a crystal structure of the provided second silicon base member 2 may be different from that of the first silicon base member 1, but is preferably the same as that thereof. In the finally obtained bonded body 3, various kinds of characteristics are uniform over a bonding interface between the first silicon base member 1 and the second silicon base member 2.

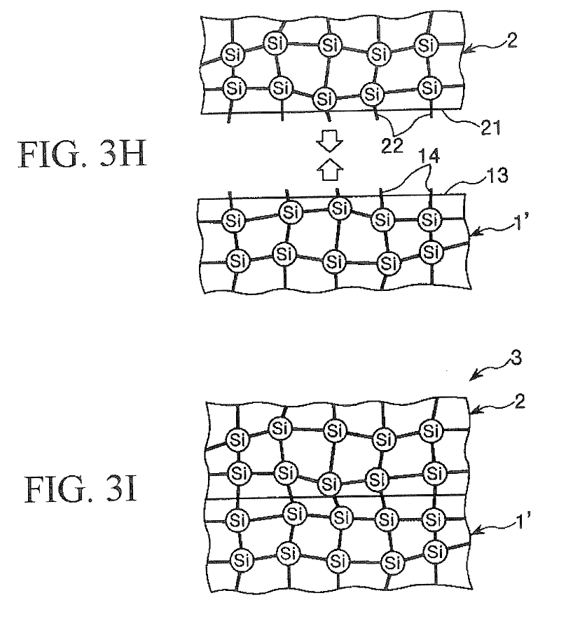

In necessary, a p-type dopant and an n-type dopant may be added to the second silicon base member 2. The addition of the p-type dopant and the n-type dopant makes it possible to control electrical characteristics of the second silicon base member 2.

[2-2] Next, the one first silicon base member 1′ and the second silicon base member 2 are overlapped to each other so as to be in contact the cleavage surface 13 of one first silicon base member 1′ which have been cleaved in the step [1] with the surface 21 of the second silicon base member 2 provided in the step [2-1] as shown in FIG. 3H.

By performing the step, the dangling bonds 14 of silicon exposed on the cleavage surface 13 of the one first silicon base member 1′ are bonded to the dangling bonds 22 of silicon exposed on the surface 21 of the second silicon base member 2 to form Si—Si bonds. As a result, the one first silicon base member 1′ is bonded to the second silicon base member 2 to obtain a bonded body 3 as shown in FIG. 31.

In a state that the one first silicon base member 1′ described above and the second silicon base member 2 are overlapped to each other, if necessary, they are heated. This makes is possible to shorten the amount of time needed to the bonding process and increase bonding strength of the bonded body 3.

A heating temperature during the heating process is preferably in the range of about 40 to 200° C., and more preferably in the range of about 50 to 150° C. This makes is possible to shorten the amount of time needed to the bonding process and increase bonding strength of the bonded body 3. In addition, it is possible to prevent the one first silicon base member 1′ and the second silicon base member 2 from being altered and deteriorated due to the heat.

In a state that the one first silicon base member 1′ described above and the second silicon base member 2 are overlapped to each other, if necessary, they are pressed in a direction of approaching them to each other. This makes it possible to increase bonding strength of the bonded body 3.

A pressure of pressing the bonded body 3 is preferably in the range of about 1 to 1000 MPa, and more preferably in the range of about 1 to 10 MPa, although being slightly different depending on the constituent materials and thicknesses of the one first silicon base member 1′ and the second silicon base member 2, and the like.

If the pressure of pressing the bonded body 3 falls within the above range, it is possible to prevent the one first silicon base member 1′ and the second silicon base member 2 from being damaged so that it is possible to reliably increase the bonding strength of the bonded body 3.

In this regard, it is to be noted that the heating process and the pressing process are preferably performed simultaneously. By doing so, an effect by pressing and an effect by heating are exhibited synergistically. Therefore, it is possible to increase bonding strength of the bonded body 3.

It is preferred that the steps [1] and [2] as described above are performed in an inert gas (e.g. nitrogen gas and argon gas) atmosphere or a reduced-pressure atmosphere. This makes it possible to reliably prevent the cleavage surface 13 and the surface 21 from being polluted and oxidized by adhesion of oxygen and moisture contained in an atmosphere. As a result, it is possible to prevent the dangling bonds 14 exposed on the cleavage surface 13 and the dangling bonds 22 exposed on the surface 21 from being undesirably end-capped (inactivated) by oxygen and moisture.

In this regard, it is to be note that the dangling bonds 14 exposed on the cleavage surface 13 of the first silicon base member 1′ and the dangling bonds 22 exposed on the surface 21 of the second silicon base member 2 disappear over time. Therefore, after the dangling bonds 14 of silicon are exposed on the cleavage surface 13 of the first silicon base member 1′ in the step [1-2], the step [2-2] is performed as soon as possible.

Likewise, after the dangling bonds 22 of silicon are exposed on the surface 21 of the second silicon base member 2 in the step [2-1], the step [2-2] is performed as soon as possible.

Specifically, after the steps [1-2] and [2-1] are completed, this step [2-2] is preferably performed within 5 minutes, and more preferably within 3 minutes. The performance of the step [2-2] within such a time make it possible to obtain sufficient bonding strength when the one first silicon base member 1′ and the second silicon base member 2 are bonded to each other in this step [2-2]. This is because a sufficient active state is maintained in the cleavage surface 13 and the surface 21.

In the bonding method of the silicon base members as described above, the cleavage surface 13 of the one first silicon base member 1′ which is used as a silicon base member to be bonded together has high smoothness property. Therefore, it is possible to be in contact the surface 21 of the second silicon base member 2 with the cleavage surface 13 of the one first silicon base member 1′ with high adhesion, so that it is possible to bond them together with high strength and high accuracy.

Further, it is possible for the bonding method according to the present invention to bond the surface 21 of the second silicon base member 2 to the cleavage surface 13 of the one first silicon base member 1′ with sufficient bonding strength without the heating process at a high temperature. Therefore, it is possible to prevent the second silicon base member 2 and the one first silicon base member 1′ from being altered and deteriorated due to the heat.

Furthermore, according to the present invention, when the cleavage surface 13 of the one first silicon base member 1′ and the surface 21 of the second silicon base member 2 are bonded to each other, the cleavage surface 13 and the surface 21 are bonded together by Si—O—Si bonds.

Therefore, it is possible to obtain uniform characteristics (mechanical characteristics, electric characteristics, and chemical characteristics) in the one first silicon base member 1′ and the second silicon base member 2 as compared with a case that bonding surfaces are bonded to each other by Si—O—Si bonds as a conventional bonded body.

### Second Embodiment

Next, a description will be made on a second embodiment of the bonding method of the silicon base members according to the present invention.

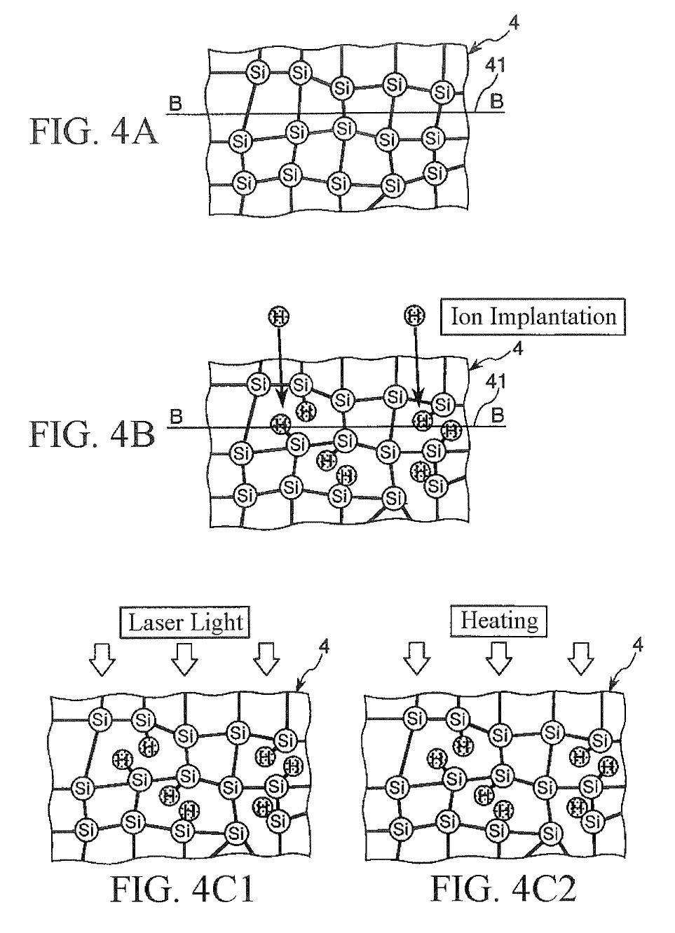

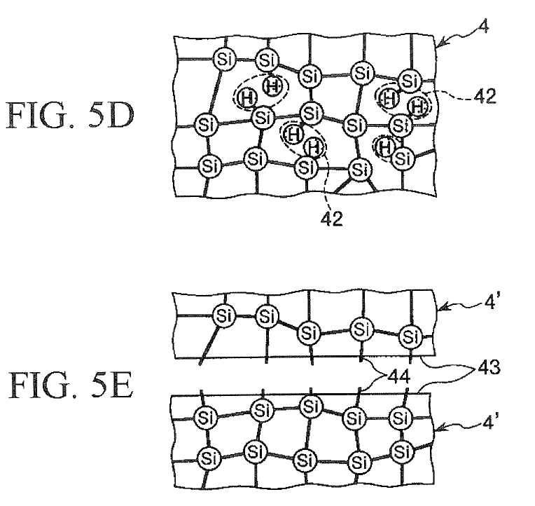

FIGS. 4A to 4C2 and FIGS. 5D and 5E are vertical sectional views for explaining a second embodiment of a bonding method of silicon base members according to the present invention. In this regard, it is to be noted that in the following description, an upper side in each of FIGS. 4A to 4C2 and FIGS. 5D and 5E will be referred to as “upper” and a lower side thereof will be referred to as “lower”.

Hereinafter, the second embodiment of the bonding method of the silicon base members will be described by placing emphasis on the points differing from the first embodiment of the bonding method of the silicon base members, with the same matters omitted from the description.

The bonding method of the silicon base members according to this embodiment is the same as that of the first embodiment except that a first step is different from that of the first embodiment. Hereinafter, a description will be made on each step of the embodiment one after another.

In this regard, it is to be noted that a first silicon base member 4 is cleaved along a B-B line shown in FIGS. 4A and 4B in this embodiment. Hereinafter, a surface shown by the B-B line is referred to as “surface 41 to be cleaved” or simply “surface 41”.

[1] Cleavage Step of First Silicon Base Member (First Step)

In this embodiment, the first step includes [1-1] a step of providing a first silicon base member 4 including Si—H bonds and [1-2] a step of applying energy to the first silicon base member 4. In this regard, as such a first silicon base member 4, a silicon material that the Si—H bonds are positioned along a surface 41 to be cleaved as shown in FIG. 4A is used. By performing the steps, the Si—H bonds are cut selectively to eliminate (remove) hydrogen atoms, and then the eliminated hydrogen atoms are bonded to each other to thereby generate a hydrogen gas.

A large volume of this hydrogen gas is occupied in the first silicon base member 4. Therefore, the first silicon base member 4 is pushed up at a part therein where the hydrogen gas is generated, so that the first silicon base member 4 is cleaved along the surface 41 to be cleaved. Hereinafter, a description will be made on the steps one after another.

[1-1] In this embodiment, the silicon material that the Si—H bonds are positioned along the surface to be cleaved as shown in FIG. 4A is used as the first silicon base member 4 including the Si—H bonds which is provided in this step. Such a first silicon base member 4 is reliably cleaved at the surface 41 to be cleaved by applying the energy thereto in the step described later.

Examples of a constituent material of the first silicon base member 4 include amorphous silicon, crystal silicon, and the like, which are the same as those of the first embodiment.

As shown in FIG. 4B, hydrogen atoms or hydrogen ions are implanted to the silicon material of such a constitute material so as to remain to the surface to be cleaved. By doing so, it is possible to obtain a first silicon base member 4 in which the Si—H bonds are positioned along the surface 41 to be cleaved.

In this way, if the hydrogen atoms or the hydrogen ions are implanted to the silicon material, a first silicon base member 4 constituted of a silicon material containing no hydrogen can be used for the bonding method according to the present invention to perform a bonding process.

A method of implanting the hydrogen atoms or the hydrogen ions into the silicon material can be performed by an ion implantation method using ion implantation equipment. At this time, it is possible to control positions of the hydrogen atoms or the hydrogen ions to be implanted in the first silicon base member 4 and allow them to remain to the surface 41 to be cleaved by appropriately changing an ion accelerating voltage in implanting the ions.

Specifically, the ion accelerating voltage is preferably in the range of about 0.2 to 150 kV, and more preferably in the range of about 1 to 90 kV. By setting the ion accelerating voltage to fall within the above noted range, it is possible to reliably implant the hydrogen atoms or the hydrogen ions into the silicon material while preventing the first silicon base member 4 constituted of the silicon material from being damaged due to too large energy of the implanted ions.

In this regard, in a case where the first silicon base member 4 is constituted of crystal silicon, it is preferred that a crystal surface is parallel to the surface 41 of the first silicon base member 4 to be cleaved. Since this helps that the cleavage is generated along the crystal surface of the first silicon base member 4, the obtained cleavage surface 43 exhibits high smoothness property.

[1-2] Next, energy is applied to the first silicon base member 4. This makes it possible to cleave the first silicon base member 4 at the surface 41 to be cleaved thereof.

A method of applying the energy to the first silicon base member 4 is not limited a specific method as long as the Si—H bonds are selectively cut without altering and deteriorating that. In this embodiment, particularly, a method of irradiating light such as laser light to the first silicon base member 4 or a method of heating the first silicon base member 4 can be used preferably.

Among the methods, the method of irradiating the laser light to the first silicon base member 4 makes it possible to selectively and efficiently cut the Si—H bonds while reliably preventing the first silicon base member 4 from being altered and deteriorated as shown in FIG. 4c1. Further, according to the laser light, it is possible to locally apply the energy to the surface 41 to be cleaved. Such a method makes it possible to selectively cut only the Si—H bonds existing at (to) the vicinity of the surface 41 to be cleaved.

Therefore, in a case where mechanism elements and circuits are formed in the first silicon base member 4, it is possible to avoid adverse affect with the heat to them. Various kinds of conditions of irradiating such a laser beam are the same as those described in the first embodiment.

In this embodiment, the Si—H bonds are positioned along the surface 41 to be cleaved. Therefore, even if laser light having high directionality is not used, but light having low directionality which spreads in a radial fashion is used, it is possible to selectively cut only the Si—H bonds existing on the surface 41 to be cleaved. As a result, it is possible to reliably cleave the first silicon base member 4 at the surface 41 to be cleaved, thereby dividing the first silicon base member 4 to obtain one first silicon base member 4′ and the other first silicon base member 4′.

As shown in FIG. 4c2, in a case where the first silicon base member 4 is heated, the heating process is performed by using a heater, an infrared light, or the like. At this time, a temperature of heating the first silicon base member 4 is preferably in the range of about 300 to 600° C., and more preferably in the range of about 400 to 500° C. By setting the heating temperature to fall within the above noted range, it is possible to selectively cut only the Si—H bonds without cutting most of the Si—Si bonds.

Further, a time of heating the first silicon base member 4 is not limited to a specific value, but preferably in the range of about 1 to 10 minutes, and more preferably in the range of about 0.5 to 5 minutes in a case where the heating temperature falls within the above noted range. In this embodiment, since the Si—H bonds can be selectively cut by the heating process, it is possible to perform this step with ease without the use of expensive equipment.

As described above, when the Si—H bonds are cut, bonding hands of silicon atoms to which hydrogen atoms has been bonded become dangling bonds 44. On the other hand, two hydrogen atoms eliminated (removed) from the silicon atoms are bonded to each other, so that a hydrogen gas 42 is generated at the vicinity of the surface 41 to be cleaved as shown in FIG. 5D.

A large volume of this hydrogen gas 42 is occupied in the first silicon base member 4. Therefore, the first silicon base member 4 is pushed up at the surface 41 to be cleaved. If stress generated by that reaches fracture stress of the first silicon base member 4, the first silicon base member 4 is cleaved at the surface 41 to be cleaved in an up-down direction thereof, thereby dividing the first silicon base member 4. In this way, two first silicon base members 4′ are obtained, which are referred to as one first silicon base members 4′ and the other first silicon base members 4′.

The dangling bonds 44 of silicon are exposed on cleavage surfaces 43 of the two first silicon base members 4′. This is a state of high activity. In this regard, it is to be noted that the cleavage surfaces 43 have higher smoothness property than that of a surface of a silicon substrate which is polished.

It is preferred that the application of such an energy is performed in a reduced-pressure atmosphere or an inert gas atmosphere such as a nitrogen gas atmosphere, an argon gas atmosphere and the like. This makes it possible to reliably prevent the cleavage surfaces 43 from being polluted or oxidized by adherence of oxygen and moisture contained in an atmosphere. As a result, it is possible to prevent dangling bonds 44 exposed on the cleavage surfaces 43 from being undesirably end-capped (non-activated) with oxygen and hydroxyl groups.

[2] Bonding Step of Silicon Base Members (Second Step)

The second step is performed in the same manner as the step [2] of the first embodiment described above. The one first silicon base member 4′ and the second silicon base member 2 are overlapped to each other so as to be in contact the cleavage surface 43 of the one first silicon base member 4′ obtained in the step [1] with the surface 21 of the second silicon base member 2 provided separately.

By performing the step, the dangling bonds 44 of silicon exposed on the cleavage surface 43 of the one first silicon base member 4′ are bonded to the dangling bonds 22 of silicon exposed on the surface 21 of the second silicon base member 2 to form Si—Si bonds. As a result, the one first silicon base member 4′ is bonded to the second silicon base member 2 to obtain a bonded body 3.

The bonding method of the silicon base members as described above exhibits the same actions and effects as those of the bonding method of the silicon base members of the first embodiment.

According to this embodiment, since the hydrogen ions are selectively implanted into the vicinity of the surface 41 of the first silicon base member 4 to be cleaved, no hydrogen ions exist in parts other than the vicinity of the surface 41 to be cleaved. If a large amount of hydrogen ions is implanted thereto, there is a case that mechanical characteristics and electrical characteristics of the first silicon base member 4 are lowered. However, the use of the bonding method according to this embodiment can avoid this case (problem).

The bonded body of the silicon base members obtained by using the bonding method of the silicon base members as described above can be used in some applications. Examples of such applications include semiconductor elements, MEMS, various kinds of packages and the like. Hereinafter, a description will be made on a case where the bonded body obtained by using the bonding method of the silicon base members according to the present invention is used for a diode (semiconductor element).

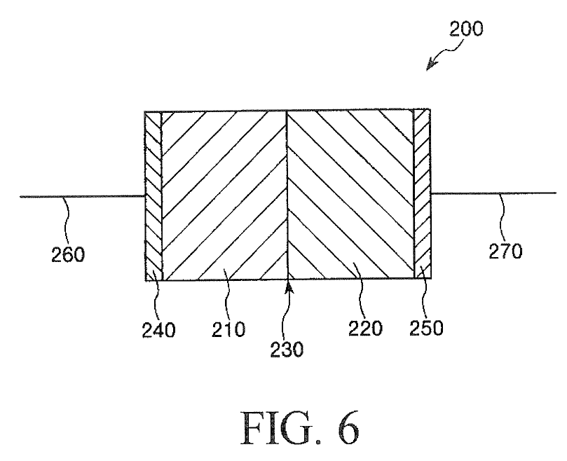

FIG. 6 is a vertical sectional view showing a diode produced by using the bonding method of the silicon base members according to the present invention. In the following description, the left side in FIG. 6 will be referred to as “left” and the right side thereof will be referred to as “right” for convenience of explanation.

A diode 200 shown in FIG. 6 has a p-type silicon base member 210 and an n-type silicon base member 220 which are bonded together at a bonding surface 230.

An anode 240 is provided to a left surface of the p-type silicon base member 210, and a cathode 250 is provided to a right surface of the n-type silicon base member 220. Furthermore, a lead 260 is connected with the anode 240 and a lead 270 is connected with the anode 250.

Here, the p-type silicon base member 210 is constituted of a material in which a low amount of a p-type dopant of a trivalent element such as boron (B), indium (In), and the like is added to a silicon material of amorphous silicon containing hydrogen, a crystal silicon containing hydrogen, or the like.

On the other hand, the n-type silicon base member 220 is constituted of a material in which a low amount of a n-type dopant of a pentavalent element such as phosphorous (P), arsenic (As), antimony (Sb), and the like is added to the same silicon material as that of the p-type silicon base member 210.

Such a p-type silicon base member 210 and n-type silicon base member 220 is bonded to each other by using the bonding method according to the present invention. In this way, the p-type silicon base member 210 and the n-type silicon base member 220 are bonded together in a state of very low contact resistance.

As a result, the p-type silicon base member 210 and the n-type silicon base member 220 are bonded together with a pn bonding, so that the diode 200 exhibits commutating action. The diode 200 obtained by using the bonding method according to the present invention has high reliability.

Ink Jet Type Recording Head

Now, a description will be made on an embodiment of a droplet ejection head in which the bonded body produced by using the bonding method of the silicon base members according to the present invention is used.

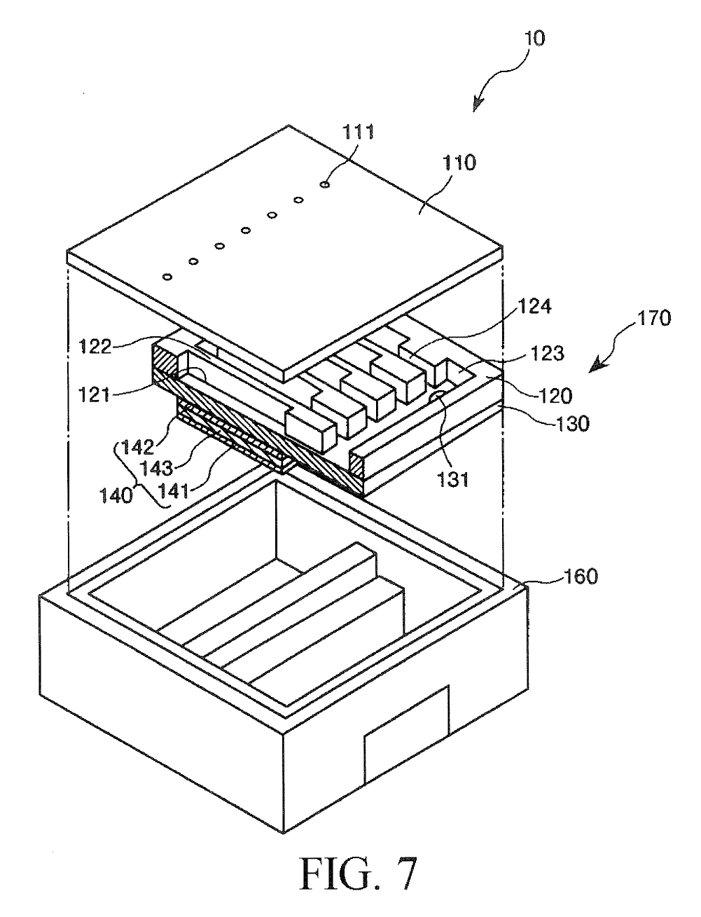

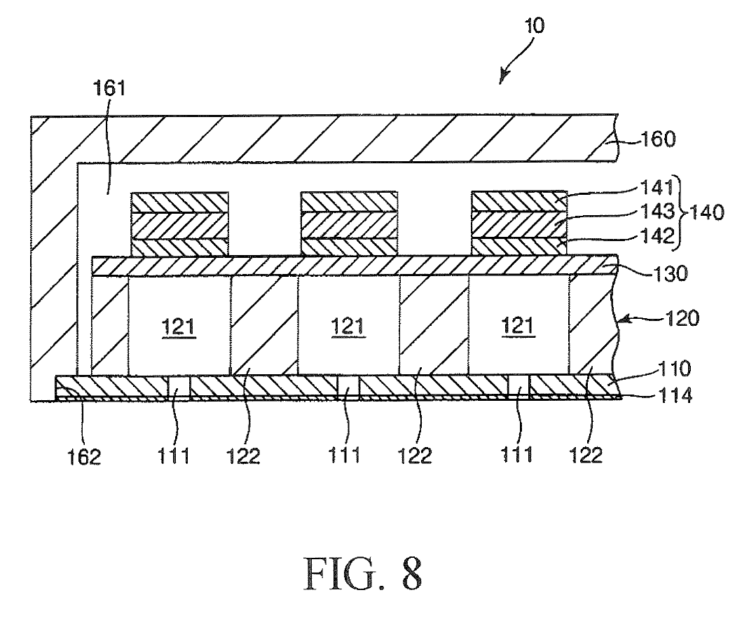

FIG. 7 is an exploded perspective view showing an ink jet type recording head (a droplet ejection head) in which the bonded body according to the present invention is used. FIG. 8 is a sectional view illustrating major parts of the ink jet type recording head shown in FIG. 7.

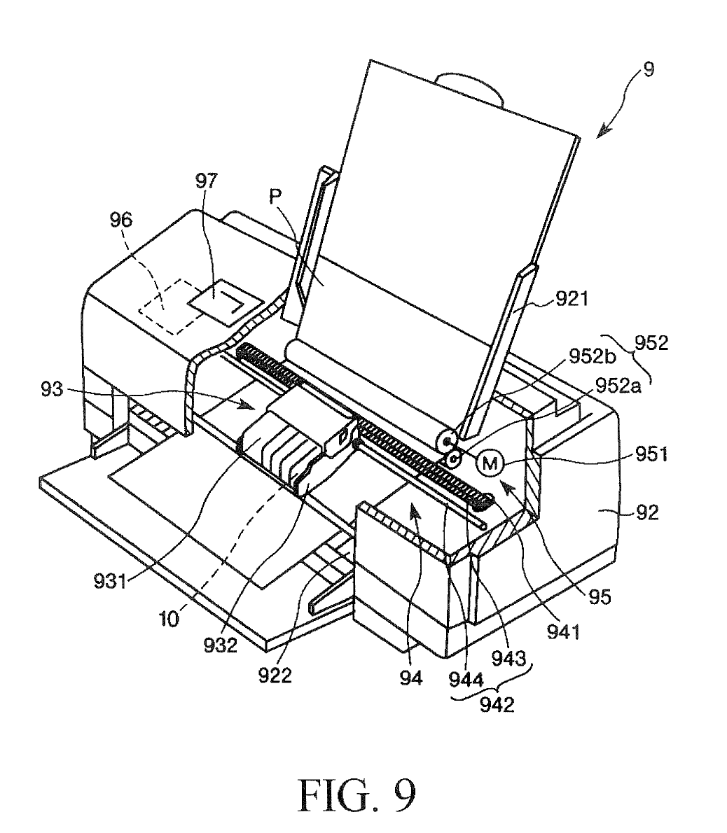

FIG. 9 is a schematic view showing one embodiment of an ink jet printer equipped with the ink jet type recording head shown in FIG. 7. In FIG. 7, the ink jet type recording head is shown in an inverted state as distinguished from a typical use state.

The ink jet type recording head (droplet ejection head according to the present invention) 10 shown in FIG. 7 is mounted to the ink jet printer (droplet ejection apparatus according to the present invention) 9 shown in FIG. 9.

The ink jet printer 9 shown in FIG. 9 includes a printer body 92, a tray 921 provided in the upper rear portion of the printer body 92 for holding recording paper sheets P, a paper discharging port 922 provided in the lower front portion of the printer body 92 for discharging the recording paper sheets P therethrough, and an operation panel 97 provided on the upper surface of the printer body 92.

The operation panel 97 is formed from, e.g., a liquid crystal display, an organic EL display, an LED lamp or the like. The operation panel 97 includes a display portion (not shown) for displaying an error message and the like and an operation portion (not shown) formed from various kinds of switches.

Within the printer body 92, there are provided a printing device (a printing means) 94 having a reciprocating head unit 93, a paper sheet feeding device (a paper sheet feeding means) 95 for feeding the recording paper sheets P into the printing device 94 one by one and a control unit (a control means) 96 for controlling the printing device 94 and the paper sheet feeding device 95.

Under the control of the control unit 96, the paper sheet feeding device 95 feeds the recording paper sheets P one by one in an intermittent manner. The recording paper sheet P passes near the lower portion of the head unit 93. At this time, the head unit 93 makes reciprocating movement in a direction generally perpendicular to the feeding direction of the recording paper sheet P, thereby printing the recording paper sheet P.

In other words, an ink jet type printing operation is performed, during which time the reciprocating movement of the head unit 93 and the intermittent feeding of the recording paper sheets P act as primary scanning and secondary scanning, respectively.

The printing device 94 includes a head unit 93, a carriage motor 941 serving as a driving power source of the head unit 93 and a rotated by the carriage motor 941 for reciprocating the head unit 93.

The head unit 93 includes an ink jet type recording head 10 (hereinafter, simply referred to as “a head 10”) having a plurality of formed in the lower portion thereof, an ink cartridge 931 for supplying ink to the head 10 and a carriage 932 carrying the head 10 and the ink cartridge 931.

Full color printing becomes available by using, as the ink cartridge 931, a cartridge of the type filled with ink of four colors, i.e., yellow, cyan, magenta and black.

The reciprocating mechanism 942 includes a carriage guide shaft 943 whose opposite ends are supported on a frame (not shown) and a timing belt 944 extending parallel to the carriage guide shaft 943.

The carriage 932 is reciprocatingly supported by the carriage guide shaft 943 and fixedly secured to a portion of the timing belt 944.

If the timing belt 944 wound around a pulley is caused to run in forward and reverse directions by operating the carriage motor 941, the head unit 93 makes reciprocating movement along the carriage guide shaft 943. During this reciprocating movement, an appropriate amount of ink is ejected from the head 10 to print the recording paper sheets P.

The paper sheet feeding device 95 includes a paper sheet feeding motor 951 serving as a driving power source thereof and a pair of paper sheet feeding rollers 952 rotated by means of the paper sheet feeding motor 951.

The paper sheet feeding rollers 952 include a driven roller 952a and a driving roller 952b, both of which face toward each other in a vertical direction, with a paper sheet feeding path (the recording paper sheet P) remained therebetween. The driving roller 952b is connected to the paper sheet feeding motor 951.

Thus, the paper sheet feeding rollers 952 are able to feed the plurality of recording paper sheets P, which are held in the tray 921, toward the printing device 94 one by one. In place of the tray 921, it may be possible to employ a construction that can removably hold a paper sheet feeding cassette containing the recording paper sheets P.

The control unit 96 is designed to perform printing by controlling the printing device 94 and the paper sheet feeding device 95 based on the printing data inputted from a host computer, e.g., a personal computer or a digital camera.

Although not shown in the drawings, the control unit 96 is mainly comprised of a memory that stores a control program for controlling the respective parts and the like, a piezoelectric element driving circuit for driving piezoelectric elements (vibration sources) 14 to control an ink ejection timing, a driving circuit for driving the printing device 94 (the carriage motor 941), a driving circuit for driving the paper sheet feeding device 95 (the paper sheet feeding motor 951), a communication circuit for receiving printing data from a host computer, and a CPU electrically connected to the memory and the circuits for performing various kinds of control with respect to the respective parts.

Electrically connected to the CPU are a variety of sensors capable of detecting, e.g., the remaining amount of ink in the ink cartridge 931 and the position of the head unit 93.

The control unit 96 receives printing data through the communication circuit and then stores them in the memory. The CPU processes these printing data and outputs driving signals to the respective driving circuits, based on the data thus processed and the data inputted from the variety of sensors. Responsive to these signals, the piezoelectric elements 14, the printing device 94 and the paper sheet feeding device 95 come into operation, thereby printing the recording paper sheets P.

Hereinafter, the head (droplet ejection head according to the present invention) 10 will be described in detail with reference to FIGS. 7 and 8.

The head 10 includes a head main body 170 and a base body (casing) housing the head main body 170. The head main body 170 includes a nozzle plate (first base member) 110 in which a plurality of nozzle holes 111 are formed, an ink chamber base plate (second base member) 120 provided with a reservoir (liquid reservoir space) 121 for temporarily reserving an ink (liquid) and disposed so as to correspond to the nozzle holes 111.

Furthermore, the head main body 170 includes a vibration plate 130 for changing a volume of the reservoir 121, and a plurality of piezoelectric elements (vibration sources) 140 bonded to the vibration plate 130. The head 10 constitutes a piezo jet type head of on-demand style.

The nozzle plate 110 is made of, e.g., a silicon-based material such as SiO₂, SiN or quartz glass, a metallic material such as Al, Fe, Ni, Cu or alloy containing these metals, an oxide-based material such as alumina or ferric oxide, a carbon-based material such as carbon black or graphite, and the like.

A plurality of nozzle holes 111 for ejecting ink droplets therethrough is formed in the nozzle plate 110. The pitch of the nozzle holes 111 is suitably set according to the degree of printing accuracy.

The ink chamber base plate 120 is fixed or secured to the nozzle plate 110. In the ink chamber base plate 120, there are formed a plurality of ink chambers (cavities or pressure chambers) 121, a reservoir chamber 123 for reserving ink supplied from the ink cartridge 931 and a plurality of supply ports 124 through which ink is supplied from the reservoir chamber 123 to the respective ink chambers 121. These chambers 121, 123 and 124 are defined by the nozzle plate 110, the side walls (barrier walls) 122 and the below mentioned vibration plate 130.

The respective ink chambers 121 are formed into a reed shape (a rectangular shape) and are arranged in a corresponding relationship with the respective nozzle holes 111. Volume of each of the ink chambers 121 can be changed in response to vibration of the vibration plate 130 as described below. Ink is ejected from the ink chambers 121 by virtue of this volume change.

In this embodiment, the ink chamber base plate 120 is constituted from a silicon substrate. The nozzle plate 110 and the ink chamber base plate 120 are bonded to each other by using the bonding method of the silicon base members according to the present invention. In this way, the nozzle plate 110 and the ink chamber base plate 120 are bonded together with high strength and high accuracy.

As a result, it is possible to suppress variations of volumes of the respective ink chambers 121, the reservoir chamber 123, and the plurality of supply ports 124. This makes it possible to uniformly eject the inks from the nozzle holes 111.

The vibration plate 130 is bonded to the opposite side of the ink chamber base plate 120 from the nozzle plate 110. The plurality of piezoelectric elements 140 are provided on the opposite side of the vibration plate 130 from the ink chamber base plate 120.

In a predetermined position of the vibration plate 130, a communication hole 131 is formed through a thickness of the vibration plate 130. Ink can be supplied from the ink cartridge 931 to the reservoir chamber 123 through the communication hole 131.

Each of the piezoelectric elements 140 includes an upper electrode 141, a lower electrode 142 and a piezoelectric body layer 143 interposed between the upper electrode 141 and the lower electrode 142. The piezoelectric elements 140 are arranged in alignment with the generally central portions of the respective ink chambers 121.

The piezoelectric elements 140 are electrically connected to the piezoelectric element driving circuit and are designed to be operated (vibrated or deformed) in response to the signals supplied from the piezoelectric element driving circuit.

The piezoelectric elements 140 act as vibration sources. The vibration plate 130 is vibrated by operation of the piezoelectric elements 140 and has a function of instantaneously increasing internal pressures of the ink chambers 121.

In this embodiment, a droplet ejection means is composed from the vibration plate 130 and the piezoelectric elements 140. The droplet ejection means ejects the inks reserved in the ink chambers 121 from the nozzle holes 111 as droplets.

The base body 160 has a recess portion 161 that can receive the head main body 170. In a state that the head main body 17 is received in a recess portion 161 of the base body 160, an edge of the nozzle plate 110 is supported on a shoulder 162 of the base body 160 extending along an outer circumference of the recess portion 161.

With the head 10 set forth above, no deformation occurs in the piezoelectric body layer 143, in the case where a predetermined ejection signal has not been inputted from the piezoelectric element driving circuit, that is, a voltage has not been applied between the upper electrode 141 and the lower electrode 142 of each of the piezoelectric elements 140.

For this reason, no deformation occurs in the vibration plate 130 and no change occurs in the volumes of the ink chambers 121. Therefore, the ink droplets have not been ejected from the nozzle holes 111.

On the other hand, the piezoelectric body layer 143 is deformed, in the case where the predetermined ejection signal is inputted from the piezoelectric element driving circuit, that is, the voltage is applied between the upper electrode 141 and the lower electrode 142 of each of the piezoelectric elements 140.

Thus, the vibration plate 130 is heavily deflected to change the volumes of the ink chambers 121. At this moment, pressures within the ink chambers 121 are instantaneously increased and the ink droplets are ejected from the nozzle holes 111.

When one ink ejection operation has ended, the piezoelectric element driving circuit ceases to apply the voltage between the upper electrode 141 and the lower electrode 142. Thus, the piezoelectric elements 140 are returned substantially to their original shapes, thereby increasing the volumes of the ink chambers 121.

At this time, a pressure acting from the ink cartridge 931 toward the nozzle holes 111 (a positive pressure) is imparted to the ink. This prevents an air from entering the ink chambers 121 through the nozzle holes 111, which ensures that the ink is supplied from the ink cartridge 931 (the reservoir chamber 123) to the ink chambers 121 in a quantity corresponding to the quantity of the ink ejected.

By sequentially inputting ejection signals from the piezoelectric element driving circuit to the piezoelectric elements 140 lying in target printing positions, it is possible to print an arbitrary (desired) letter, figure or the like.

The head 10 may be provided with thermoelectric conversion elements in place of the piezoelectric elements 140. In other words, the head 10 may have a configuration in which the ink is ejected using a thermal expansion of a material caused by the thermoelectric conversion elements (which is sometimes called a bubble jet method wherein the term “bubble jet” is a registered trademark).

In the head 10 configured as above, a film 114 is formed on the nozzle plate 110 in an effort to impart liquid repellency thereto. By doing so, it is possible to reliably prevent the ink droplets from adhering to peripheries of the nozzle holes 111, which would otherwise occur when the ink droplets are ejected from the nozzle holes 111.

As a result, it becomes possible to make sure that the ink droplets ejected from the nozzle holes 111 are reliably landed (hit) on target regions.

Electronic Device

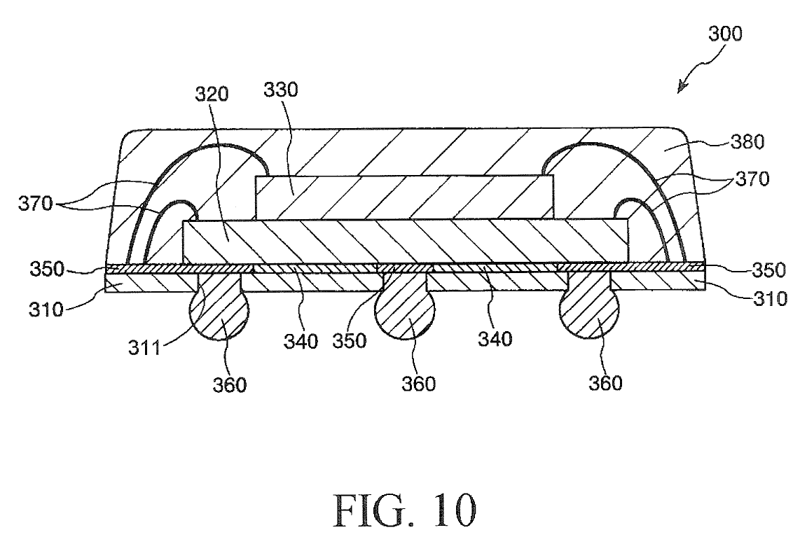

Now, a description will be made on an embodiment of an electronic device in which the bonded body of the silicon base members produced by using the bonding method of the silicon base members according to the present invention is used. FIG. 10 is a vertical sectional view showing an electronic device produced by using the bonding method of the silicon base members according to the present invention. In the following description, the upper side in FIG. 10 will be referred to as “upper” and the lower side thereof will be referred to as “lower” for convenience of explanation.

An electronic device (an electronic device according to the present invention) 300 shown in FIG. 10 includes an insulating substrate 310, a silicon tip 320 mounted on the insulating substrate 310 through a insulating layer 340 and a conductive layer 350, and a silicon tip 330 mounted on the silicon tip 320.

The insulating layer 340 and the conductive layer 350 are provided between the insulating substrate 310 and the silicon tip 320. The conductive layer 350 is bonded to solder balls 360 inserted in through holes 311 which are formed through the insulating substrate 310. In this way, the conductive layer 350 is conducted with the solder balls 360.

In this regard, a circuit (not shown) is formed in the two silicon tips 320 and 330, respectively. The circuit is formed by using a general semiconductor manufacture process.

One ends of wires 370 are connected with the circuits formed in the silicon tips 320 and 330, respectively. On the other hand, the other ends of the wires 370 are connected with the conductive layer 350 formed on the insulating substrate 310. In this way, the circuit formed in each of the two silicon tips 320 and 330 is electrically connected with the solder balls 360.

Furthermore, a sealing portion 380 is provided on the insulating substrate 310. The sealing portion 380 insulates and seals the two silicon tips 320 and 330, and the wires 370 by covering them.

In such an electronic device 300, the two silicon tips 320 and 330 are bonded to each other by using the bonding method of the silicon base members according to the present invention. Specifically, one of the two silicon tips 320 and 330 corresponds to the first silicon base member described above, and the other thereof corresponds to the second silicon base member described above. Therefore, it is possible to firmly bond the two silicon tips 320 and 330 together and improve position accuracy thereof. As a result, the electronic device 300 exhibits high reliability.

By laminating the two silicon tips 320 and 330, it is possible to easily package three-dimensionally. This makes it possible to reduce a planner size of the electronic device 300. If the planner size of the electronic device 300 is the same as those of others electronic devices, it is possible to easily improve components per chip of the electronic device 300.

Although the bonding method of the silicon base members, the droplet ejection head, the droplet ejection apparatus, and the electronic device according to the present invention has been described above based on the embodiments illustrated in the drawings, the present invention is not limited thereto.

In the embodiments described above, the cleavage is generated at one surface of the first silicon base member, but may be generated at two surfaces or more thereof. Furthermore, three or more silicon base members may be bonded to each other. If necessary, one or more arbitrary step may be added in the bonding method of the silicon base members according to the present invention.

### INDUSTRIAL APPLICABILITY

A bonding method of silicon base members according to the present invention comprises: providing a first silicon base member including Si—H bonds; applying an energy to the first silicon base member to selectively cut the Si—H bonds so that the first silicon base member is cleaved and divided to one silicon base member and the other silicon base member, and the one silicon base member having a cleavage surface; providing a second silicon base member having a surface on which dangling bonds of silicon atoms are exposed; and bonding the cleavage surface of the one silicon base member and the surface of the second silicon base member to thereby bond the cleavage surface and the surface together.

Therefore, it is possible to accurately and firmly bond the silicon base members together without performance of a heat treatment at a high temperature. Further, by bonding the cleavage surface exhibiting superior smoothness property as a bonding surface of the first silicon base member to the surface of the second silicon base member, it is possible to reliably bond the first silicon base member and the second base member. Therefore, it is possible to bond them together with high bonding strength and high accuracy.

Furthermore, the first silicon base member is bonded to the second silicon base member with Si—Si bonds at a bonding interface therebetween. Therefore, they are firmly bonded to each other as compared with bonding based on Si—O—Si bonds as a conventional bonding method. Consequently, uniform mechanical characteristics, uniform electrical characteristics, and uniform chemical characteristics are obtained between the first silicon base member and the second silicon base member. Accordingly, the bonding method of the silicon base members according to the present invention has industrial applicability.

What is claimed is:

1. A bonding method of silicon base members, the bonding method comprising:
applying an energy to a first silicon base member including Si—H bonds to selectively cut the Si—H bonds so that the first silicon base member is cleaved and divided to one silicon base member and the other silicon base member, and the one silicon base member having a cleavage surface and dangling bonds of silicon obtained by cutting the Si—H bonds; and
bonding the cleavage surface of the one silicon base member and a surface of a second silicon base member on which dangling bonds of silicon are exposed to thereby bond the cleavage surface and the surface together through their dangling bonds.

2. The bonding method of the silicon base members as claimed in claim 1, wherein the first silicon base member is constituted of hydrogenated amorphous silicon or crystal silicon including hydrogen.

3. The bonding method of the silicon base members as claimed in claim 2, wherein the first silicon base member constituted of the hydrogenated amorphous silicon is formed by a CVD method or a plasma polymerization method using a silane gas as a raw gas.

4. The bonding method of the silicon base members as claimed in claim 1, wherein the energy includes a laser light, and the applying the energy to the first silicon base member is performed by irradiating the laser light to the first silicon base member.

5. The bonding method of the silicon base members as claimed in claim 4, wherein the laser light includes a pulse laser.

6. The bonding method of the silicon base members as claimed in claim 4, wherein the first silicon base member has a part in which the laser light has been irradiated, and conditions of irradiating the laser light to the first silicon base member are adjusted so that a temperature of the part is in the range of 300 to 600° C.

7. The bonding method of the silicon base members as claimed in claim 4, wherein the first silicon base member has a surface to be cleaved, and the applying the energy to the first silicon base member is performed by scanning the laser light along the surface to be cleaved in a state that the laser light is focused to the surface of the first silicon base member to be cleaved.

8. The bonding method of the silicon base members as claimed in claim 7, wherein the Si—H bonds included in the first silicon base member are distributed along the surface of the first silicon base member to be cleaved.

9. The bonding method of the silicon base members as claimed in claim 8, wherein the first silicon base member in which the Si—H bonds are distributed along the surface to be cleaved is constituted of a silicon material formed by implanting hydrogen atoms or hydrogen ions into the surface to be cleaved.

10. The bonding method of the silicon base members as claimed in claim 9, wherein the silicon material is crystal silicon having a crystal surface, the crystal surface of the crystal silicon is substantially parallel to the surface of the first silicon base member to be cleaved.

11. The bonding method of the silicon base members as claimed in claim 8, wherein the first silicon base member is cleaved at the surface to be cleaved by heating the first silicon base member.

12. The bonding method of the silicon base members as claimed in claim 11, wherein a temperature of heating the first silicon base member is in the range of 300 to 600° C.

13. The bonding method of the silicon base members as claimed in claim 1, wherein the bonding the cleavage surface of the one silicon base member and the surface of the second silicon base member is performed with heating the one silicon base member and the second silicon base member.

14. The bonding method of the silicon base members as claimed in claim 13, wherein a temperature of heating the one silicon base member and the second silicon base member is in the range of 40 to 200° C.

15. The bonding method of the silicon base members as claimed in claim 1, wherein the bonding the cleavage surface of the one silicon base member and the surface of the second silicon base member is performed with pressing the one silicon base member and the second silicon base member in a direction of approaching them to each other.

16. The bonding method of the silicon base members as claimed in claim 15, wherein a pressure of pressing the one silicon base member and the second silicon base member is in the range of 1 to 1000 MPa.

17. The bonding method of the silicon base members as claimed in claim 1, wherein the applying the energy to the first silicon base member and the bonding the cleavage surface of the one silicon base member and the surface of the second silicon base member are performed in an inert gas atmosphere or a reduced-pressure atmosphere.

18. The bonding method of the silicon base members as claimed in claim 1, wherein the second silicon base member is provided by providing a silicon base member including Si—H bonds; and applying an energy to the silicon base member to selectively cut the Si—H bonds included in the silicon base member to obtain the exposed dangling bonds of silicon so that the silicon base member is cleaved and divided to the second silicon base member and a silicon base member.

19. The bonding method of the silicon base members as claimed in claim 1, wherein the second silicon base member is provided by:
providing a silicon base member having a surface;
subjecting the silicon base member to an etching treatment using a hydrofluoric acid-containing liquid to form Si—H bonds on the surface of the silicon base member; and
applying an energy to the etching-treated surface of the silicon base member to selectively cut the Si—H bonds so that the dangling bonds are exposed on the surface of the silicon base member corresponding to the second silicon base member.

20. A droplet ejection head provided with a bonded body manufactured by bonding two silicon base members together, wherein the bonded body is manufactured by the bonding method of the silicon base members defined in claim 1.

21. A droplet ejection apparatus provided with the droplet ejection head defined in claim 20.

22. An electronic device provided with a bonded body manufactured by bonding two silicon base members together, wherein the bonded body is manufactured by the bonding method of the silicon base members defined in claim 1.
